(19) United States
(12) Patent Application Publication
(10) Pub. No.: US 2007/0168386 A1
(43) Pub. Date: Jul. 19, 2007

(54) Device and method for managing multimedia content in portable digital apparatus

(75) Inventors: Myoung-soon Choi, Suwon-si (KR); Young-yoon Kim, Seoul (KR); Du-II Kim, Suwon-si (KR); Hyok-sung Choi, Anyang-si (KR); Seong-kook Shin, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 10/582,635

(22) PCT Filed: Apr. 27, 2004
(86) PCT No.: PCT/KR04/00963

§ 371 Date: Jun. 12, 2006

(30) Foreign Application Priority Data
Dec. 10, 2003 (KR) 10-2003-0089820

(51) Int. Cl. G06F 7/00

(52) U.S. Cl. 707/104.1

(57) ABSTRACT

The present invention relates to a device and method for managing multimedia content in a portable digital apparatus. An object of the present invention is to enable management of multimedia content to be stored in a portable digital apparatus equipped with a camera based on a user's preference by configuring an index for predetermined multimedia content stored in the portable digital apparatus. To this end, a device for managing multimedia content in a portable digital apparatus, comprising a storing unit for storing a plurality of multimedia content; an input unit for receiving index information from a user so that the multimedia content are classified; and a control unit for producing index information for the multimedia content with the configured indexes. The present invention provides a method for managing multimedia content by grouping the multimedia content according to his/her preference and storing them, thereby providing quick, convenient searches for the desired multimedia content.

### TECHNICAL FIELD

The present invention relates to a device and method for managing multimedia content in a portable digital apparatus, and more particularly, to enable efficient management and search of multimedia content using index information by indexing, based on a user's preference, multimedia content to be stored in a portable digital apparatus equipped with a camera and storing the indexed multimedia content.

### BACKGROUND ART

Recently, portable digital apparatuses, such as digital cameras, digital still cameras (DSC), camera cellular phones, digital video cameras (DVC), digital voice storage (e.g., MP3, voice recorders, etc.), and PDAs, have been developed and become widely popular. These portable digital apparatuses write and store images and audio data (hereinafter, referred to as ‘multimedia content’) therein, in compliance with predetermined naming rules.

DCF (Design rule for Camera File System), which has become widely known and provides a directory and file structure, is used as a standard for naming rules.

As shown in FIG. 1, the directory and file structure created under DCF has a top level of a directory named DCIM (Digital Camera Images) under a root directory, and up to 900 different directories under the DCIM directory. A directory name is 8 characters in length which consists of a non-duplicated three-digit series number (e.g., a number between 100 and 999) and the remaining five alphanumeric characters are arbitrarily named by a user.

A plurality of files may be recorded in a directory having a name of 8 characters in length, wherein each file may have a name with 8 characters in length which consists of four free alphanumeric characters specified by a user and non-duplicated four-digit series number.

The files recorded in this manner as described above may comprise still image files (*.JPG) in JPEG format, still image files (*.TIF) in TIFF format, and reduced size image files (*.THM) that are still images scaled to a predetermined small size, and also comprise wave audio files (*.WAV) formatted by means of PCM, u-law PCM, or IMA-ADPCM scheme.

The portable digital apparatuses employing such a DCF-based directory and file structure have complied with the conventions for managing multimedia content by specific directories arbitrarily created by dates.

Shooting date or any other information, e.g., series numbers, names of still camera manufactures, random numbers, etc., can be used to make the directory names.

According to the method for managing multimedia content under conventional DCF, multimedia content acquired on the same date are all stored in the same directory. However, this method is inefficient because this method for managing multimedia content is performed regardless of features of the files to be stored.

Further, in a case where certain multimedia content is continuously acquired around a date change (for example, after and before 12:00 p.m.), there may occur content that is stored in different directories created by different dates.

Thus, there is a problem in that, when a user using the multimedia content stored in the portable digital apparatus desires to search for multimedia content recorded on a specific date, confusion may occur to the user.

To mitigate the above problem caused by conventional multimedia data management method, the disclosure described in Korean patent application laidopen No. 2002-0061394, entitled ‘A method for making electronic albums’, provides a method for making electronic albums in which data are copied to a program folder so that all data are input at a time and a variety of designs are easily adapted to consumer's preferences. While this invention uses program folders for efficient data entry, this invention is, however, not enough to provide effective use of multimedia content.

Accordingly, there is a need for an efficient method for managing multimedia content by which fast access to content is achieved by classifying and storing multimedia content stored in a portable digital apparatus, based on user's preference or file features.

### DISCLOSURE OF THE INVENTION

An object of the present invention is to configure an index for predetermined multimedia content stored in a portable digital apparatus equipped with a camera so that a user can manage stored content according to a user's preference.

Further, another object of the present invention is to index and store the multimedia content based on the user's preference, thereby achieving easy access to the content through index information, at the time of searching for and displaying the content.

In a predetermined portable digital apparatus, according to the present invention, if index configuration is input for classifying multimedia content, a control unit creates index information for the multimedia content having the indexes configured, and the multimedia content are provided through a GUI screen, based on the index information.

The input of the index configuration for classifying the multimedia content may be made by using a physical button (hereinafter, referred to as ‘indexing function button’) provided on the exterior of the portable digital apparatus, or by using a user menu provided through the GUI screen configured by the control unit.

Further, the GUI screen showing the multimedia content having the indexes configured presents multimedia content under folders classified based on the index information, or presents only multimedia content with configured tag information.

According to an aspect of the present invention, there is provided a device for managing multimedia content in a portable digital apparatus, comprising a storing unit for storing a plurality of multimedia content; an input unit for receiving index information from a user so that the multimedia content are classified; and a control unit for producing index information for the multimedia content with the configured indexes.

The device may further comprise an output unit for providing a GUI screen for showing the multimedia content.

Further, according to another aspect of the present invention, there is provided a method for managing multimedia content, comprising the steps of selecting multimedia content for which indexes are to be configured; and creating index information for the selected multimedia content.

The method may further comprise the step of providing multimedia content through a GUI screen.

### BRIEF DESCRIPTION OF DRAWINGS

The above and other objects and features of the present invention will become apparent from the following description of preferred embodiments given in conjunction with the accompanying drawings, in which:

FIG. 1 schematically shows a conventional DCF directory structure for storing images;

FIG. 2 schematically shows a device for managing multimedia content in a portable digital apparatus according to an embodiment of the present invention;

FIG. 3 schematically shows the process of managing multimedia content in a portable digital device according to an embodiment of the present invention;

FIG. 4 schematically shows the process of displaying multimedia content in a portable digital apparatus according to an embodiment of the present invention;

FIGS. 5 to 8 schematically show the process of managing images in a digital camera according to an embodiment of the present invention;

FIGS. 9 and 10 schematically show the process of displaying images in a digital camera according to an embodiment of the present invention; and

FIGS. 11 and 12 schematically show the process of displaying images in a digital camera according to another embodiment of the present invention.

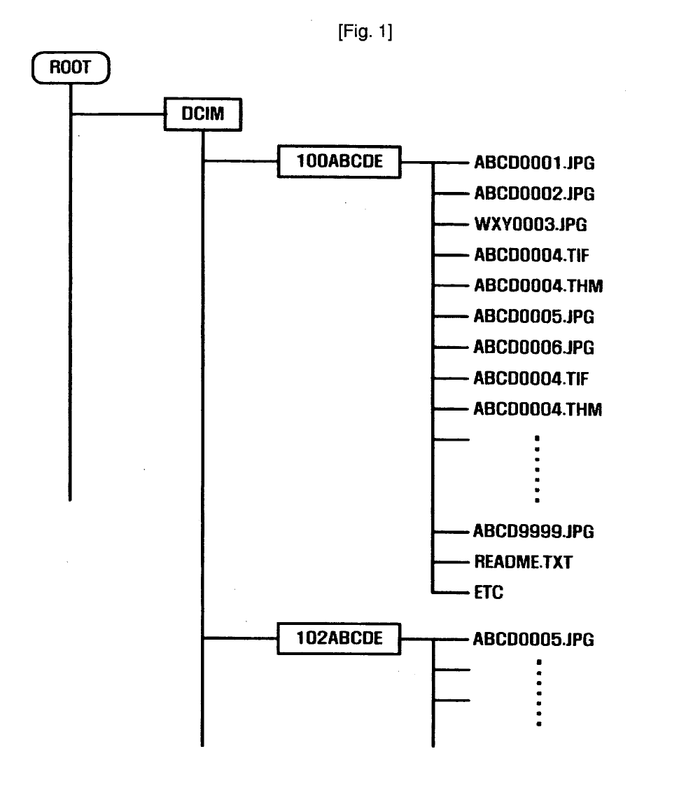

### BEST MODE FOR CARRYING OUT THE INVENTION

Hereinafter, a device and method for managing multimedia content in a portable digital apparatus according to the present invention will be described with reference to the accompanying drawings.

Although the device and method for managing multimedia content in a portable digital apparatus will be described below in connection with a digital camera that stores image data by configuring index information for the image data, this is merely illustrative. Therefore, it will be understood by those skilled in the art that various modifications and equivalents thereof can be made to this invention. For example, when various multimedia content, including audio and motion pictures, as well as image data, are stored, the multimedia content may be classified by index information configured for the multimedia content, based on index configuration selected by a user.

Further, in describing the device and method for managing multimedia content in a portable digital apparatus, metadata files for multimedia content groups, classified based on the multimedia content having indexes configured, are provided in XML format, such as MultiPhoto Video or MusicPhoto Video, as a multimedia title industry standard. Therefore, the metadata files may be recognized by various digital apparatuses for using/editing the multimedia content, as well as the portable multimedia apparatuses.

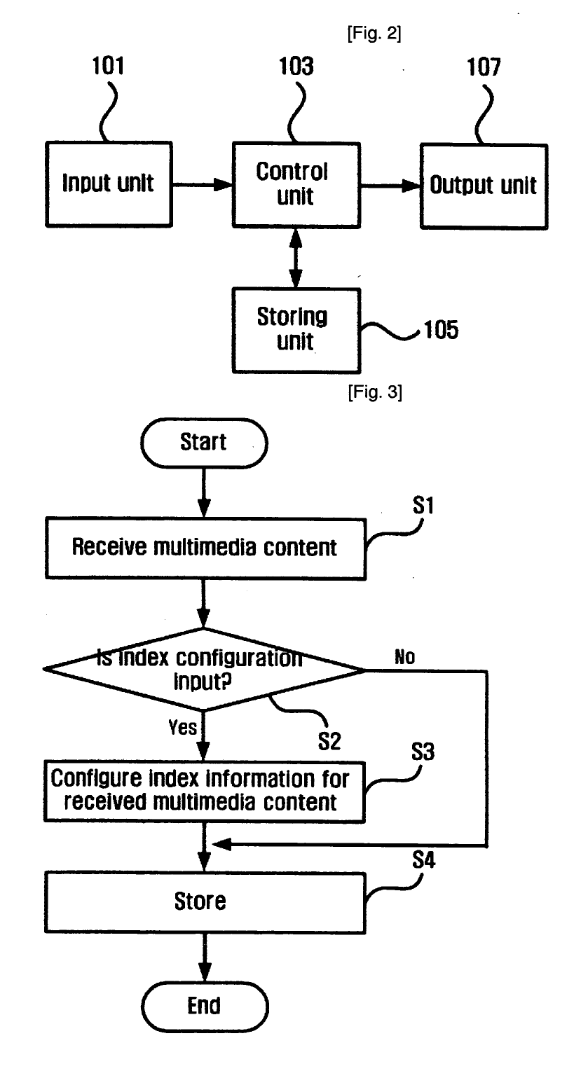

FIG. 2 schematically shows a device for managing multimedia content in a portable digital apparatus according to an embodiment of the present invention.

As shown in FIG. 2, the device for managing multimedia content according to one embodiment of the present invention comprises an input unit 101, a control unit 103, a storing unit 105, and an output unit 107.

The input unit 101 serves to receive index configuration from a user for classifying the multimedia content. For this purpose, the user may use an indexing function button located on the exterior of the portable digital apparatus and provided for entry of the index configuration, or a GUI-based user menu configured by the control unit 103.

Further, the input unit 101 receives the index configuration from the user, through the user's inputs or change of date, etc.

The control unit 103 is operated to create index information for the multimedia content having indexes configured according to the user's inputs into the input unit 101.

The control unit 103 further classifies the indexed multimedia content into groups of multimedia content, and uses the index information to manage the groups under different folders, or creates tag information for the indexed multimedia content.

Further, the control unit 103 creates metadata files for the groups of the multimedia content classified based on the indexed multimedia content.

The metadata files represent information relating to a group of multimedia content, and may contain an index name for the group, the number of the multimedia content belonging to the group, and a start or end number of multimedia content contained in the group.

The following shows an example of the metadata files classified into different albums by the groups of indexed multimedia content.

[ALBUM]
META Index Album=1
META NUM = 10
META Start_Index = 1
META End_Index = 10
[ ALBUM]
META Index Album=2
META NUM = 8
META Start_Index = 11
META End_Index = 18
[ALBUM]
META Index Album=3
META NUM=3
META Start_Index = 19
META
End_Index = 21

For example, a user who uses an MP3 player may wish to classify MP3 files when the user intends to store MP3 files in the MP3 player. For this purpose, the user may input index configuration through the input unit 101.

Then, based on the entered index configuration, the control unit 103 creates index information for the MP3 files.

If a new directory is created by an indexing function of the control unit 103, a stored image has information on the new created directory configured as an index, and predetermined MP3 files including MP3 files to be stored are placed in the new created directory.

Alternatively, if a new indexing tag is created by the indexing function of the control unit 103, new tag information are created to MP3 files as index information, and metadata files for groups of the MP3 multimedia content grouped including the indexed MP3 files are created.

The storing unit 105 is used to store multimedia content with configured index information by the control unit 103, and may be implemented with Random Access Memory, such as DRAMs, SDRAMs, or UtRAMs, etc., or Flash Memory.

The output unit 107 shows the multimedia content stored in the storing unit 105 through a GUI screen, and may be implemented in a liquid crystal display employed in the portable digital apparatus, or a display, such as TV or monitor, connected through a cable.

The GUI screen may present multimedia content placed in folders classified based on the index information of the multimedia content, or present only multimedia content with the configured tag information (e.g., a list of the multimedia content may be provided on the screen).

The control unit 103 may configure the GUI screen by recognizing the groups of multimedia content with reference to the metadata files and then searching for the multimedia content so indexed.

For example, if a user who possesses a MP3 player wishes to review MP3 files stored therein, the output unit 107 displays the MP3 files given the index information, among the stored MP3 files.

Then, if the index information corresponds to directory information created by the indexing function, the output unit 107 is caused to present the GUI screen having a directory structure configured based on the index information.

In a case where a folder is selected through the output GUI screen, the output unit 107 provides MP3 files placed in the folder searched by referring to the metadata file.

On the other hand if the index information corresponds to tag information created by the indexing function, a metadata file is referred to, in order to group MP3 files including specific MP3 files with the configured index information.

Then, the output unit 107 presents a GUI screen showing a list of MP3 files for which the indexes are configured, and also provides the grouped MP3 files, including the MP3 files selected by the user through the GUI screen.

In a device for managing multimedia content used in a portable digital apparatus according to the embodiment of the present invention, all modules therein may be implemented with hardware or software, or some of the modules may be implemented with software.

Accordingly, implementation of the device for managing multimedia content with hardware or software falls within the spirit of the present invention, and it will be apparent that modifications and variations to the implementation thereof with hardware or software can be made without departing from the spirit of the present invention.

A method of managing multimedia content using the multimedia content management device employed in the portable digital device according to the present invention will be described in detail with reference to the accompanying drawings.

A method for managing multimedia content used in a portable digital apparatus according to the present invention comprises the steps of receiving, from a user, index configuration for multimedia content which the user wishes to apply index configuration, creating index information on the multimedia content with configured indexes, and providing the multimedia content through a GUI screen according to the index information.

FIG. 3 schematically shows a multimedia content management procedure in a portable digital device according to one embodiment of the present invention.

As shown in FIG. 3, at first, multimedia content are received at step S1, then the control unit 103 determines, at step S2, if a user inputs index configuration through the input unit 101 during the recording of the received multimedia content into the storing unit 105.

If it is determined that index configuration is selected, the control unit 103 creates indexes for the multimedia content received, based on the input indexing configuration (step S3), and then stores them in the storing unit 105.

If it is determined that the index configuration is not input, the control unit 103 stores the multimedia content received in the storing unit 105.

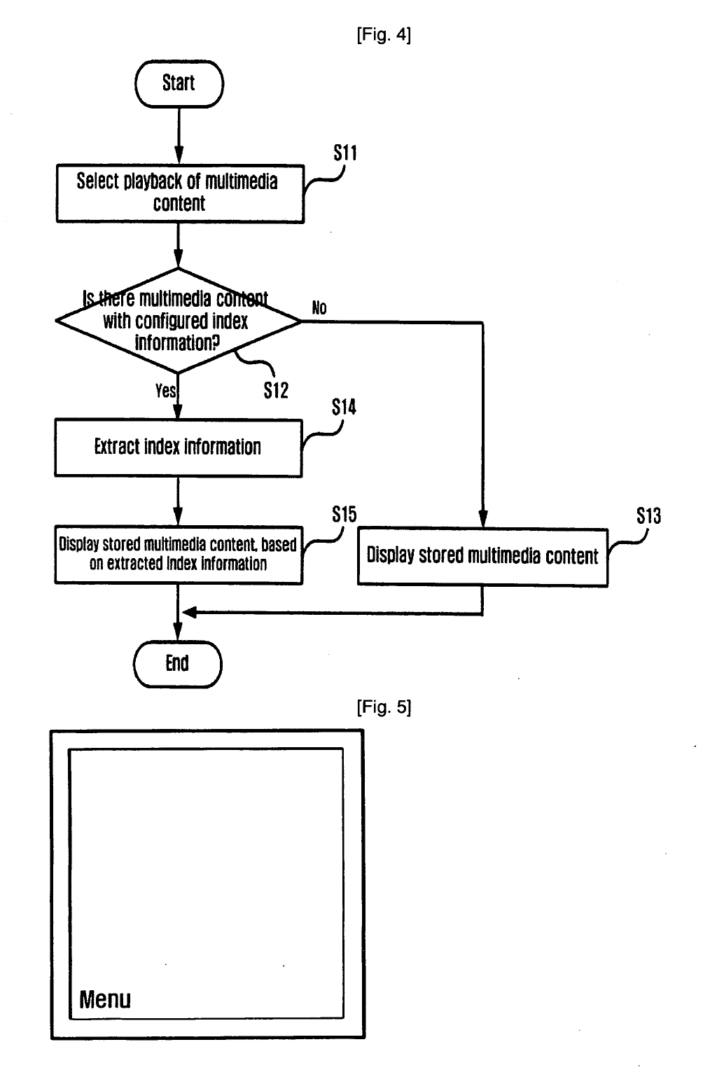

FIG. 4 schematically shows a procedure of displaying multimedia content from the portable digital apparatus according to one embodiment of the present invention.

As shown in FIG. 4, in step S11, in a case where a user selects a search function for multimedia content stored in the portable digital apparatus, the control unit 103 reads the multimedia content stored in the storing unit 105.

Then, the control unit 103 uses its indexing function to read the multimedia content and then determine whether or not there are multimedia content with index information configured, among the read multimedia content (S12).

If it is determined that no multimedia content with configured index information is found, the control unit 103 displays the multimedia content read from the storing unit 105, in a predetermined display method (S13).

If it is determined that there exist multimedia content with configured index information, the control unit 103 extracts the relevant index information and metadata file (S14), and, based on the extracted information, configures a predetermined GUI screen to display the associated multimedia content through the output unit 105 (S15).

Hereinafter, a method for managing the multimedia content used in a portable digital device according to one embodiment of the present invention will be described in detail, with reference to the accompanying drawings.

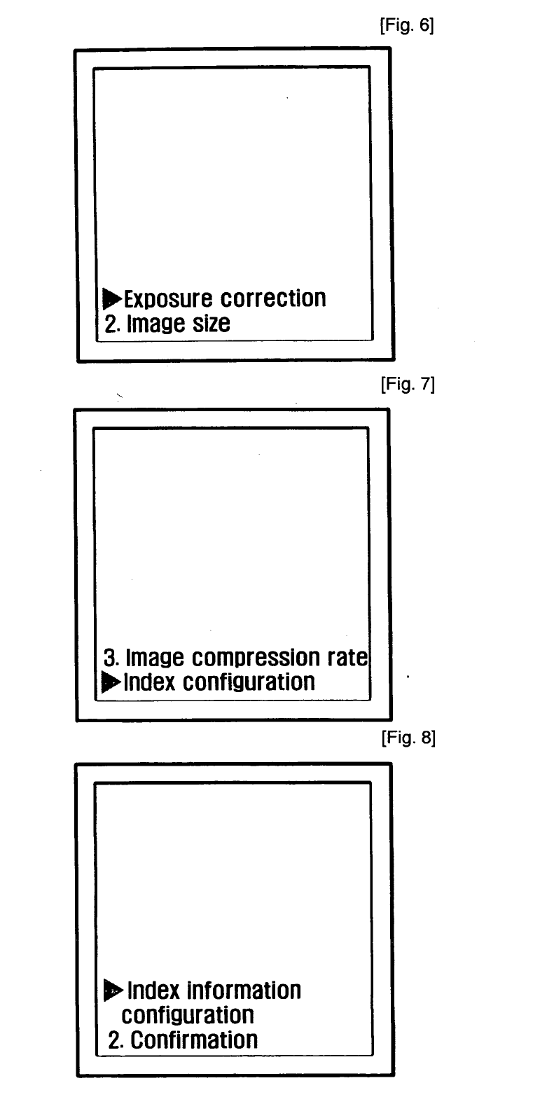

FIGS. 5 and 6 schematically show file management and display procedures employed in digital cameras according to one embodiment of the present invention.

A current date may be used for permitting the management of new images captured by a user using the digital camera. For this purpose, the user selects a shooting mode and then shoots a picture.

Then, in order to configure index information to the captured image displayed on an LCD monitor of the digital camera, the user selects a menu button MENU provided on the exterior of the digital camera for managing the captured images, as shown in FIG. 5.

When such a menu button is selected, the control unit 103 shows a sub-menu for managing the images on a lower left portion of the LCD monitor, as shown in FIG. 6.

The user uses a predetermined navigation button to navigate in the sub-menu, and then selects the desired indexing function by selecting a confirmation or ENTER button.

With the selection of the confirmation button by the user, the control unit 103 shows a sub-menu associated with the selected indexing function, as shown in FIG. 7.

A configuration menu for configuring indexes for the currently captured images is activated using the navigation button, and the confirmation button is then selected.

When the index configuration is made for the captured images through the above procedures, the control unit 103 configures the index information for the captured images, based on the indexing function.

If the index information configured by the indexing function corresponds to directory information, the control unit 103 creates a new directory (e.g., 20031203abc) having its name combined with the current date for separately managing predetermined images, including the current image.

Next, the control unit 103 configures the created directory information (20031203abc) to the captured image as index information, and then stores it.

As far as separate index information is not configured for the images shot by the user through the indexing function, these images are placed in the same directory (20031203abc) according to the index information configured for a previous image.

After predetermined images are stored, the user may again select an indexing function and configure index information for the predetermined images. At this time, predetermined images containing the above images are placed in a new directory created according to the above selected indexing function.

On the other hand, if the index information configured by the indexing function corresponds to the index tag information, the control unit 103 creates a new index tag for separately managing predetermined images including the current image by grouping the predetermined images.

Next, the control unit 103 configures the created tag information for the captured image as the index information, records file information for the images with the configured tag information, into a metadata file, and stores it in the storing unit 105.

If the user selects the indexing function after the predetermined images shot by the user have been stored in the storing unit 105, new indexing tags for the current images are again created and configured for the associated image. Further, the metadata file is updated with file information for the images with newly configured tag information.

If the user who stored predetermined shot images in the digital camera through the above procedures intends to review the stored images, the user may select the playback PLAY button for searching for the stored images.

In case of the playback button being thus selected, the control unit 103 determines if there exist images with the configured index information among the images stored in the storing unit 105, and searches for the images having the configured index information.

Then, the stored images are provided on a predetermined GUI screen, based on the index information of the searched images.

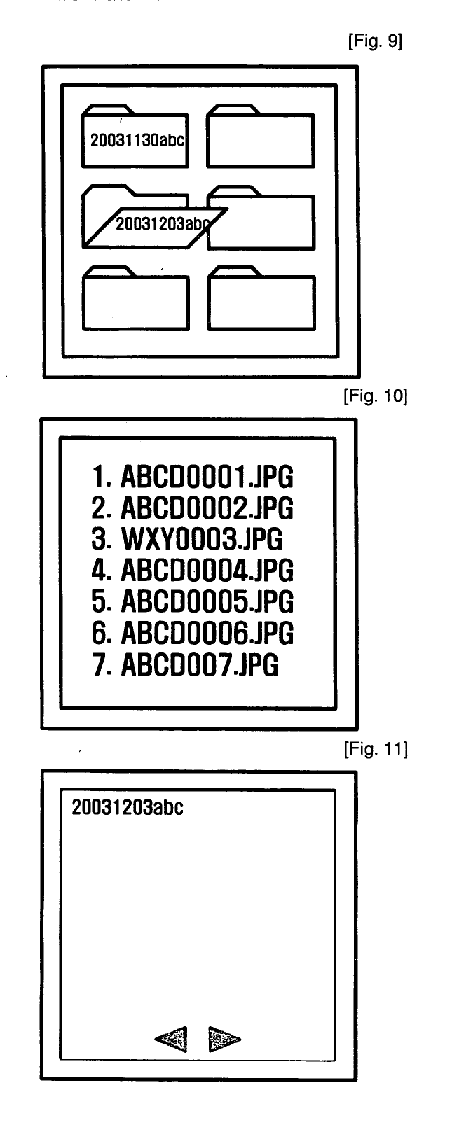

If the index information consists of directory information, a GUI screen containing folder images for respective directories is displayed on the LCD monitor, as shown in FIG. 9.

The user may use the predetermined navigation button to activate a folder image for a desired directory to be searched, and then selects the confirmation button.

When specific directory (e.g., 20031203abc) is selected by the user, the control unit 103 shows, as shown in FIG. 10, a list of the images stored in the specific directory through the output unit 107.

Further, the control unit 103 may provide images stored in the specific directory using a slide show function, through the output unit 103.

If the index information consists of tag information, the control unit 103 refers to the metadata file to search for the images to be grouped, based on the images with the configured index information and the index information of the relevant images.

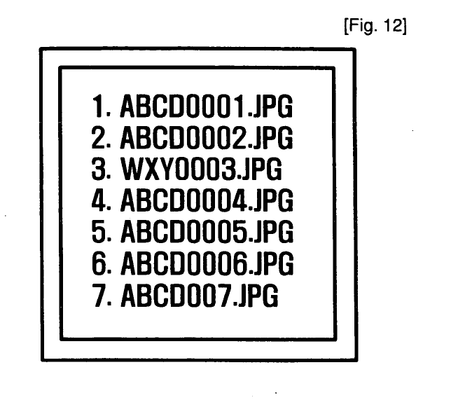

Then, as shown in FIG. 11, a slide show function may be activated to provide slide shows for the images with the configured index information. Moreover, if a specific image is selected by the user, a list of images grouped based on the index information, which are showed through the slide shows, is provided, as shown in FIG. 12.

Furthermore, the control unit 103 provides the grouped images using the slide shows through the output unit 107.

Another embodiment of the present invention may be provided which the indexing function is performed using the indexing button provided on the exterior of the digital camera.

The indexing function activated by the indexing button is performed in the same manner as that of the indexing function by the menu button.

According to the foregoing, the user may manage the images shot on a specific date, but this invention is not limited thereto, the captured images may also be managed by places, place names, etc.

Accordingly, the true technical scope of the present invention should be defined by the appended claims.

### INDUSTRIAL APPLICABILITY

According to the present invention, the present invention has an advantage in that a user can manage multimedia content stored in a portable digital apparatus by configuring preferred indexes for predetermined multimedia content.

Further, the present invention provides a method for managing multimedia content by grouping the multimedia content according to his/her preference and storing them, thereby providing quick, convenient searches for the desired multimedia content.

Although the present invention has been described in connection with the embodiments illustrated in the drawings, it will be apparent to those skilled in the art that various substitutions, modifications and changes may be made thereto without departing from the technical spirit and scope of the invention. Thus, the present invention is not limited to the embodiments and the accompanying drawings.

1. A device for managing multimedia content in a portable digital apparatus, the device comprising:
an input unit which receives an index information from a user for configuring indexes of multimedia content;
a control unit which produces index information for the multimedia content having the indexes configured according to the received index configuration and
a storing unit which stores the multimedia content with the index information.

2. The device as claimed in claim 1, further comprising an output unit which provides a graphical user interface (GUI) screen for showing the multimedia content

3. The device as claimed in claim 1, wherein the input unit comprises at least one of a physical button, and a user menu using a graphical user interface (GUI) screen.

4. The device as claimed in claim 1, wherein the control unit is configured to group predetermined multimedia content into a single multimedia group, for the multimedia content with the configured indexes.

5. The device as claimed in claim 4, wherein the control unit is configured to manage the multimedia content under different folders.

6. The device as claimed in claim 4, wherein the control unit is configured to create tag information for the multimedia content with the configured indexes.

7. The device as claimed in claim 4, wherein the control unit is configured to create metadata files for the grouped multimedia content for the multimedia content with the configured indexes.

8. The device as claimed in claim 7, wherein the metadata file comprises at least an index name for a group, and a start or end number of multimedia content contained in the group, wherein the multimedia belongs to the group.

9. The device as claimed in claim 8, wherein the metadata file is provided in extensible markup language (XML) format.

10. The device as claimed in claim 4, wherein the control unit is configured to represent the multimedia content under folders, based on the index information, or to represent only multimedia content with the configured tag information.

11. A method for managing multimedia content, the method comprising:
selecting multimedia content for which indexes are to be configured; and
creating index information for the selected multimedia content.

12. The method as claimed in claim 11, further comprising providing multimedia content through a graphical user interface (GUI) screen.

13. The method as claimed in claim 11, wherein the selecting multimedia content comprises at least one of input from a user, and change of date.

14. The method as claimed in claim 11, wherein the creating the index information comprises grouping predetermined multimedia content into a single multimedia group, for the multimedia content with the configured indexes.

15. The method as claimed in claim 14, wherein the creating the index information comprises managing the multimedia content under different folders.

16. The method as claimed in claim 14, wherein the creating the index information comprises creating tag information for the multimedia content with the configured indexes.

17. The method as claimed in claim 14, wherein the creating the index information comprises creating metadata files for the multimedia content grouped for the multimedia content with the configured indexes.

18. The method as claimed in claim 17, wherein the metadata file comprises at least an index name for a group, and a start or end number of multimedia content contained in the group, wherein the multimedia belongs to the group.

19. The method as claimed in claim 18, wherein the metadata file is provided in extensible markup language (XML) format.

20. The method claimed in claim 12, wherein the providing the GUI screen comprises representing the multimedia content under folders, based on the index information or representing only multimedia content with the configured tag information.
